(19) United States
(12) Patent Application Publication
(10) Pub. No.: US 2012/0252269 A1
(43) Pub. Date: Oct. 4, 2012

(54) STRUCTURE OF CONNECTOR

(76) Inventor: CHING-KUN HUANG, New Taipei City (TW)

(21) Appl. No.: 13/072,790

(22) Filed: Mar. 28, 2011

(51) Int. Cl. H01R 13/46

(52) U.S. Cl. 439/586

(57) ABSTRACT

An improved structure of connector includes a sheath and a conductive terminal that is received in the sheath. The sheath includes first and second sheath members. The first sheath member has an end forming a flange and an opposite end forming a plurality of elastic segments. The second sheath member forms a receiving chamber in which the first sheath member is receivable and also forms, inside an end thereof, a positioning section on which the elastic segments are positionable. As such, when an external terminal pin is inserted into the second sheath member to engage the conductive terminal, the positioning section retains the elastic segments in position to prevent the insertion of the external terminal pin from being made in an incorrect, deviated direction and thus damaging the conductive terminal. The arrangement of the elastic segments provides the conductive terminal with better capability of bearing external damages.

### (a) TECHNICAL FIELD OF THE INVENTION

The present invention generally relates to a connector, and more particularly to an improved structure of connector that protects a conductive terminal thereof from undesired deformation and makes the conductive terminal more capable of bearing external damages.

### (b) DESCRIPTION OF THE PRIOR ART

A terminal that functions for connection and electrical conduction must be provided for a communication device, such as a telecommunication connector, a cable connector, or a distributor. The conductive terminal may be of varied category and structure, but has an essential common function of electrical connection and transmission of signal.

A cable connector comprises an enclosure sheath, which is composed of a first sheath member and a second sheath member. The first sheath member has an end that forms a circumferential flange having an expanded diameter and an opposite end forming a receiving compartment for receiving a conductive terminal. The receiving compartment may be fit to the second sheath member to fit therein. When the second sheath member is fit to the receiving compartment, an end of the second sheath member is set on the flange for positioning and retention. As such, after the conductive terminal is put into and received in the receiving compartment, the second sheath member is then fit thereto to complete the assembling.

However, the above described conventional sheath has the following drawbacks that must be further improved:

When it is attempted to fit a sheath to which a conductive terminal is mounted to an external terminal pin, due to the fact that the receiving compartment is of a cylindrical configuration and is substantially of no elastic resiliency, fitting to the external terminal pin causes undesired deformation of the conductive terminal. Further, the conventional conductive terminal is incapable of bearing strong external damages. In addition, undesired positional shift may occur on the conductive terminal.

Thus, it is desirable to provide an improve structure of connector to overcome such drawbacks.

### SUMMARY OF THE INVENTION

In view of the above discussed, the present invention aims to provide an improved structure of connector that offers excellent protections of conductive terminal against undesired deformation and makes the conductive terminal more capable of bearing external damages.

An objective of the present invention is to provide a connector, which comprises a positioning section that functions to position and retain elastic segments of a conductive terminal so as to protect the conductive terminal from damage caused by improper insertion of an external terminal pin in an incorrect, deviated direction and which provides an arrangement of elastic segments that provides the conductive terminal with better capable of bearing external damages.

To achieve the above objective, the present invention provides a connection that comprises a sheath and a conductive terminal that is received in the sheath. The sheath comprises a first sheath member, which has an end forming an expanded flange and an opposite end forming a plurality of elastic segments. The elastic segments form gaps therebetween. The first sheath member is received in a second sheath member. The second sheath member forms a receiving chamber in which the first sheath member is receivable. The second sheath member forms, inside an end thereof, a positioning section on which the elastic segments are positionable. When an external terminal pin is inserted into the second sheath member to engage the conductive terminal, the positioning section retains the elastic segments in position to prevent the insertion of the external terminal pin from being made in an incorrect, deviated direction and thus damaging the conductive terminal. This arrangement provides a solution for the drawbacks that insertion of an external terminal pin into the sheath that is assembled with a conductive terminal may cause undesired deformation of the conductive terminal due to a receiving compartment being made cylindrical and thus lacking of elastic resiliency, that the conductive terminal is incapable of bearing strong external damages, and that the conductive terminal is susceptible to positional shifting.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment according to the present invention.

FIG. 2 is an exploded view of the preferred embodiment of the present invention.

FIG. 3 is a perspective view illustrating an initial phase of insertion of a terminal pin into a connector according to the present invention.

FIG. 4 is a cross-sectional view illustrating a final phase of the insertion of the terminal pin into the connector according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

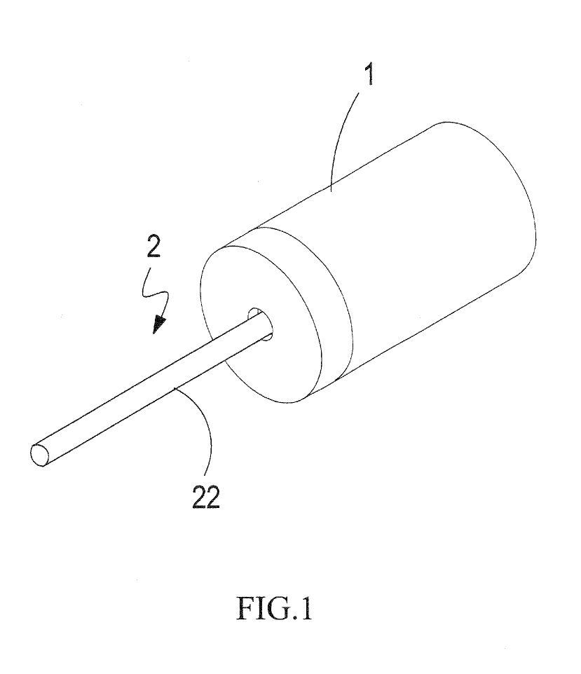

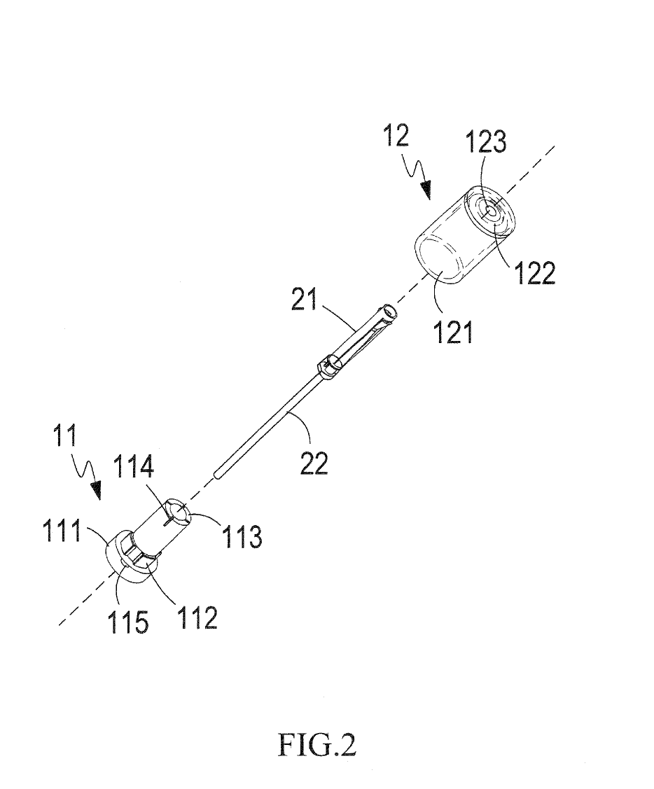

Referring to FIGS. 1 and 2, which are respectively a perspective view and an exploded view of a preferred embodiment according to the present invention, the drawings clearly show that the present invention provides a connector that comprises a sheath 1 and a conductive terminal 2 that is received in the sheath 1. The conductive terminal 2 comprises a resilient coupling section 21 and a conductive pin 22 connected to the resilient coupling section 21 and extending outside the sheath 1. The sheath 1 comprises a first sheath member 11 and a second sheath member 12.

The first sheath member 11 has an end forming a circumferential flange 111, and at least one raised rib 112 (multiple ribs being visible in the drawings) is formed at the connection of the flange 111 with the first sheath member 11. These ribs 112 define an outside diameter that is smaller than an outside diameter of the flange 111. The first sheath member has an opposite end forming a plurality of elastic segments 113, between adjacent ones of which a gap 114 is defined. Further, the first sheath member 11 forms a first opening 115 in a portion that is opposite to the end forming the elastic segments 113.

The second sheath member 12 forms therein a receiving chamber 121 in which the first sheath member 11 is receivable. The second sheath member 12 forms inside an end thereof a positioning section 122 on which the elastic segments 113 are positionable. The second sheath member 12 forms a second opening 123 in the end thereof forming the positioning section 122.

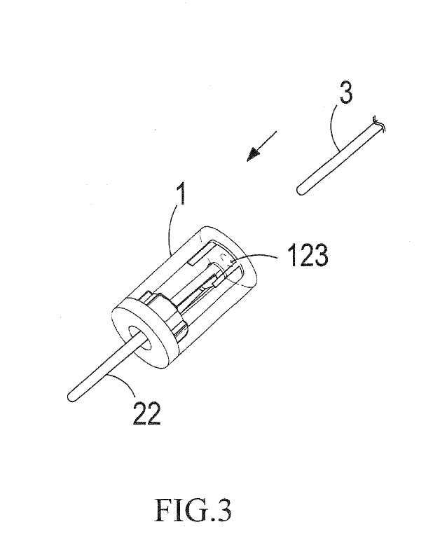

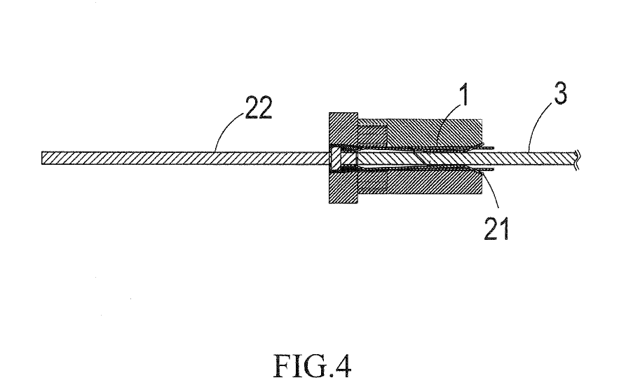

With the above structural arrangement, the operation of the present invention will be described. Reference is made to FIGS. 1-4, which are respectively a perspective view and an exploded view of the preferred embodiment of the present invention and a perspective view and a cross-sectional view illustrating insertion of a terminal pin into the connector according to the present invention, these drawings clearly show that to assemble the connector, the conductive terminal 2 is first inserted through the end of the first sheath member 11 where the elastic segments 113 are formed to have the conductive pin 22 extending outward through the first opening 115 and the resilient coupling section 21 received in the first sheath member 11. Then, the second sheath member 12 and the first sheath member 11 are fit to each other to receive the first sheath member 11 in the receiving chamber 121, whereby the elastic segments 113 are positioned on and retained by the positioning section 122. After the assembling, a terminal pin 3 is allowed to insert through the second opening 123 into the connector according to the present invention. When the terminal pin 3 is driven to fit into the resilient coupling section 21, an expansion force is induced by the terminal pin, which causes simultaneous outward expansion of the elastic segments 113 to realize protection of the resilient coupling section 21, preventing it from undesired deformation.

The above description gives an illustrative example of the present invention with reference to a preferred embodiment and it is not intended to limit the scope of the present invention with such a description. It is apparent that modifications and structural changes that are considered equivalent to what shown and illustrated in the above description, the drawings, and the appended claims are covered by the scope defined in the appended claims.

In summary, as compared to the conventional devices, the present invention provides the following advantages:

With the arrangement of the positioning section 122 to properly position the elastic segments 113, insertion of the terminal pin 3 in a deviated and incorrect direction, which may cause damage to the conductive terminal 2, can be prevented; and the arrangement of the elastic segments 113 provides the conductive terminal 2 with better capability for bearing external damage.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A connector, which comprises a sheath and a conductive terminal that is received in the sheath, wherein the sheath comprises:
a first sheath member, which has an end forming a flange and an opposite end forming a plurality of elastic segments, a gap being formed between adjacent ones of the elastic segments; and
a second sheath member, which forms a receiving chamber in which the first sheath member is receivable, the second sheath member forming inside an end thereof a positioning section on which the elastic segments are positionable.

2. The connector according to claim 1, wherein the first sheath member forms at least one rib at connection thereof with the flange, the rib defining an outside diameter that is smaller than an outside diameter of the flange.

3. The connector according to claim 1, wherein the first sheath member forms a first opening in a portion thereof that is opposite to the end forming the elastic segments.

4. The connector according to claim 1, wherein the second sheath member forms a second opening in the end forming the positioning section.

5. The connector according to claim 1, wherein the conductive terminal comprises a resilient coupling section and a conductive pin that is connected to the resilient coupling section and extends outside the sheath.
